(19) United States
(12) Patent Application Publication
(10) Pub. No.: US 2016/0209797 A1
(43) Pub. Date: Jul. 21, 2016

(54) Image Forming Apparatus Configured to Execute Duplex Printing

(71) Applicant: Brother Kogyo Kabushiki Kaisha, Nagoya-shi (JP)

(72) Inventors: Akihiro Torii, Nagoya-shi (JP); Raizo Kosaka, Nagoya-shi (JP)

(21) Appl. No.: 15/002,899

(22) Filed: Jan. 21, 2016

(30) Foreign Application Priority Data
Jan. 21, 2015 (JP) 2015-009543

(51) Int. Cl. G03G 15/00; B65H 5/36; B65H 37/00

(52) U.S. Cl. CPC G03G 15/6579; B65H 37/00; B65H 5/36

(57) ABSTRACT

An image forming apparatus has an image forming device, a sheet discharge tray, a switchback mechanism configured to reverse a conveying direction of the printing sheet to re-convey the printing sheet toward the image forming device, and a casing accommodating the image forming device. The casing has a discharge opening and a switchback discharge opening through which a part of the printing sheet is projected toward the sheet discharge tray. The image forming apparatus further has a first projection-forming device configured to form a corrugation on at least one of a first printing sheet a part of which is projected toward the sheet discharge tray through the switchback discharge opening and a second printing sheet which is to be discharged onto the sheet discharge tray through the discharge opening, the corrugation having at least one deflection which projects in a direction of thickness of the printing sheet.

### Cross-Reference to Related Application

This application claims priority under 35 U.S.C. §119 from Japanese Patent Applications No. 2015-009543 filed on Jan. 21, 2015. The entire subject matter of the application is incorporated herein by reference.

### BACKGROUND

1. Technical Field

The present disclosures relate to an image forming apparatus configured to print images on both surfaces (i.e., front and hack surfaces) of a printing sheet.

2. Related Art

An image forming apparatus provided with a switchback discharge opening in addition to a normal ejection opening through which a printing sheet is discharged from inside the image forming apparatus to a sheet discharge tray. The switchback discharge. opening is known as an opening used when an image is formed on the back surface of the printing sheet, and configured such that a part of the printing sheet to be re-conveyed toward an image forming device side is protruded therefrom to the sheet discharge tray.

### SUMMARY

When the switchback discharge opening is formed close to the normal discharge opening, the pat of the printing sheet protruded from the switchback discharge opening (hereinafter, simply referred to as a switchback sheet) and the printing sheet discharged from the normal discharge opening (hereinafter, referred to as the discharged sheet) may electrostatically attract each other.

When the switchback sheet and the discharged sheet attract each other, the discharged sheet may be moved in a direction where the discharged sheet is drawn inside the image forming apparatus through the discharge opening as the switchback sheet is re-conveyed toward the image forming device, and a malfunction in discharging of the printing sheet (which will also be referred to as a jam phenomenon) may occur.

In consideration of the above, aspects of the present disclosures proved an improved image forming apparatus configured to form images on both sides of the printing sheet with suppressing occurrence of the jam phenomenon.

According to aspects of the disclosures, there is provided an image forming apparatus, which has an image forming device configured to form images on a printing sheet, a sheet discharge tray configured to receive the printing sheet on which image formation by the image forming device has been completed, a switchback mechanism configured to reverse a conveying direction of the printing sheet to re-convey the printing sheet toward the image forming device, and a casing accommodating the image forming device, The casing has a discharge opening through which the printing sheet is discharged from inside of the casing to outside of the casing and a switchback discharge opening through which a part of the printing sheet is projected toward the sheet discharge tray, The image forming apparatus further has a first projection-forming device configured to form a corrugation on at least one of a first printing sheet a part of which is projected toward the sheet discharge tray through the switchback discharge opening and a second printing sheet which is to be discharged onto the sheet discharge tray through the discharge opening, the corrugation having at least one deflection which projects in a direction of thickness of the printing sheet.

Because of the above configuration, even if the switchback sheet and the discharge sheet contact each other, a contacting area therebetween can be made relatively small. Accordingly, an attracting force generated between the switchback sheet and the discharge sheet can also be made relatively small.

Therefore, a situation that the discharge sheet is attracted by the switchback sheet, which is being re-conveyed, and drawn toward the discharge opening 3B can be suppressed. That is, the jam phenomenon due to the attraction of the discharge sheet by the switchback sheet can be suppressed.

### BRIEF DESCRIPTION OF THE ACCOMPANYING DRAWINGS

FIG. 1 is across-sectional side view of an image forming apparatus according to an illustrative embodiment of the disclosures.

FIG. 2 an enlarged cross-sectional side view around a discharge opening and a switchback discharge opening according to the illustrative embodiment of the disclosures.

FIG. 3 an enlarged cross-sectional side view around a discharge opening and a switchback discharge opening according to the illustrative embodiment of the disclosures.

FIG. 4 an enlarged cross-sectional side view around a discharge opening and a switchback discharge opening according to the illustrative embodiment of the disclosures.

FIG. 5 schematically shows a first projection-forming part according to the illustrative embodiment of the disclosures.

FIG. 6 schematically shows a second projection-forming part according to the illustrative embodiment of the disclosures.

FIG. 7 is a cross-sectional view of a switchback sheet and a discharge sheet taken along a plane perpendicular to a conveying direction of the sheets and schematically shows an example of corrugations imparted to printing sheets.

### DETAILED DESCRIPTION OF EMBODIMENTS

It is noted that various connections are set forth between elements in the following description. It is noted that these connections in general and, unless specified otherwise, may be direct or indirect and that this specification is riot intended to be limiting in this respect.

It is noted that a printing apparatus according to the illustrative embodiment described hereinafter is color image forming apparatus configured to execute a duplex printing (i.e., to form images on both sides of a printing sheet). It is noted that arrows and indications of directions shown in each drawing are intended to clarify relationships among the drawings.

It is noted that a portion, a member or a component to which a reference number is assigned and described should be understood that at least one of the portion , member or component existed unless it is explicitly described that multiple portions, members or components exist.

### First Illustrative Embodiment

1. General Description of Image Forming Apparatus

1.1 Con figuration of Image Forming Apparatus

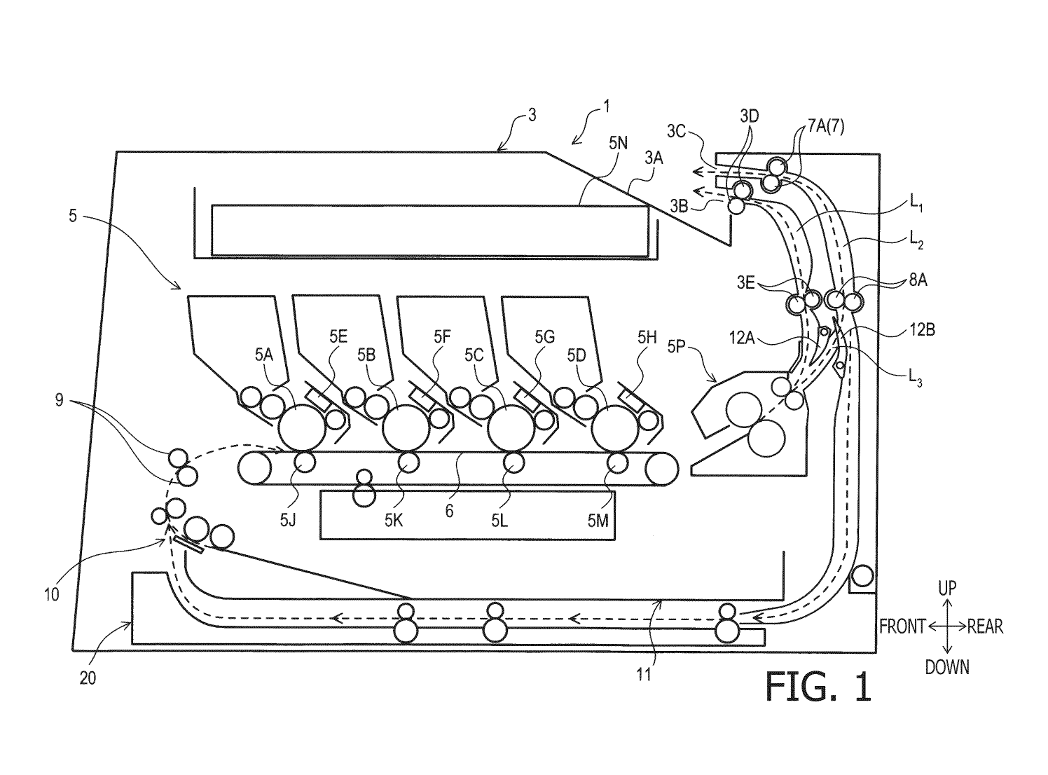

As shown in FIG. 1, an image forming apparatus 1 according to an illustrative embodiment of the disclosures has an image forming device 5, a sheet feeding device 10, a re-conveying device 20 and a casing 3 which accommodating the image forming device 5 and the like. The image forming device 5 is configured to form images on printing sheets.

The sheet feeding device 10 is configured to feed a top sheet of a plurality of printing sheets placed on a sheet feed tray 11 to the image forming device 5. The re-conveying unit 20 is configured to re-convey the printing sheet which was output from the image forming device 5 toward an inlet side of the image forming device 5.

The image forming device 5 according to the illustrative embodiment has multiple photosensitive drums 5A-5D, the same number of chargers 5E-5H, the same number of transfer rollers 5J-5M and at least one exposure device 5N and a fixing device 5P.

The photosensitive drums 5A-5D carry developing agent. The chargers 5E-5H are configured to charge the photosensitive drums 5A-5D arranged at facing positions, respectively, the exposure device 5N is configured to emit light beams to the charged photosensitive drums 5A-5D to form electrostatic latent images on circumferential surfaces of the photosensitive drums 5A-5D, respectively.

When charged developing agents are supplied to the photosensitive drums 5A-5D on which the electrostatic latent images have been formed, the developing agents are attracted by and held on the circumferential surfaces of the photosensitive drums 5A-5D. The transfer rollers 5J-5M are arranged at positions opposite to the photosensitive drums 5A-5D, respectively, with a belt 6 being sandwiched therebetween as shown in FIG. 1.

The belt 6 is configured to convey the printing sheet fed from the sheet feed tray and the fixing device 5P. The transfer rollers 5J-5M respectively cause the developing agents held by the photosensitive drums 5A-5D to be transferred onto the printing sheet which is conveyed by the belt 6. Then, the fixing device 5P permanently fixes the transferred developing agents onto the printing sheet.

Immediately above, in a vertical direction, of the casing 3, a sheet discharge tray 3A is arranged. The sheet discharge tray 3A receives the printing sheets on which image formation has been finished in a stacked manner. It is rioted that the expression “printing sheet on which image formation has been completed” means (1) the printing sheet on one surface of which an image has been formed in a simplex mode (i.e., one-side print mode), and (2) the printing sheet on both surfaces of which images have been formed in a duplex mode (i.e., both-side print mode).

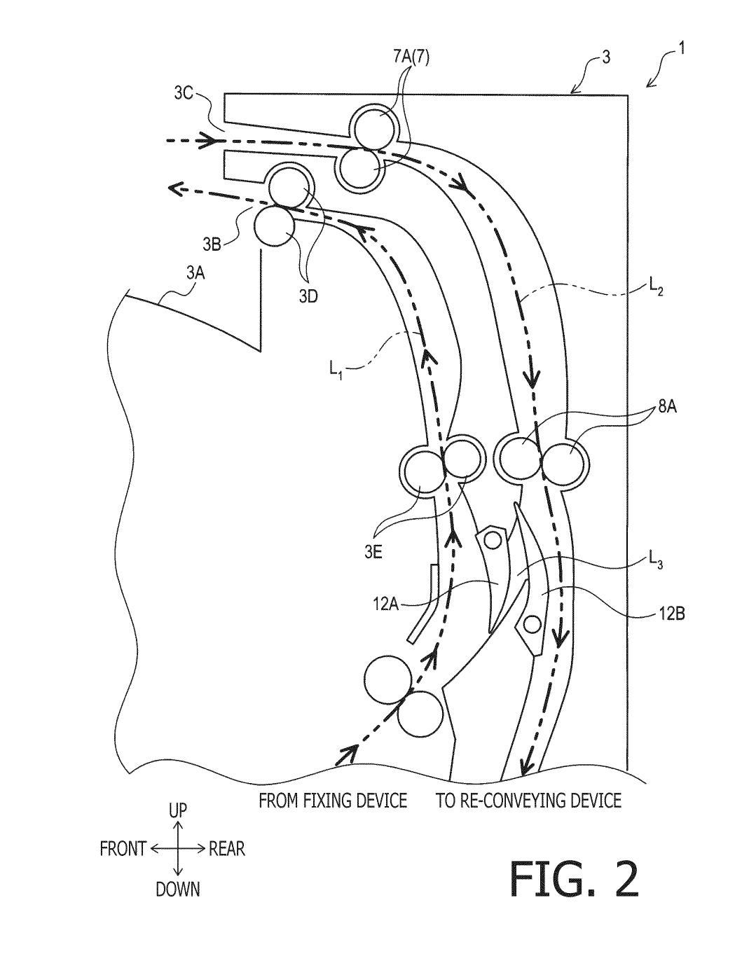

As shown in FIG. 2, inside the casing 3, a discharge opening 3B and a switch hack discharge opening 3C are formed. The switchback discharge opening 3C is arranged on an upper side, in the vertical direction, with respect to the discharge opening 3B. The discharge opening 3B is an opening for discharging the printing sheet toward the sheet discharge tray 3A.

The switchback discharge opening 3C is an opening through which a part of the printing sheet, which is re-conveyed toward the image forming device 5 (or the re-conveying unit 20) by a switchback mechanism 7, is ejected toward the sheet discharge tray 3A. It is noted that the printing sheet ejected from the switchback discharge opening 3C will not be completely discharged from the switchback discharge opening 3C, or stacked on the sheet discharge tray 3A.

The switchback mechanism 7 is configured to reverse a conveying direction of the printing sheet on one surface of which an image has been formed, and reconvert the sheet toward the image forming device 5 (or the re-conveying device 20). The switchback mechanism 7 according to the present disclosures has a pair of switchback rollers 7A which sandwich that printing sheet in its thickness direction.

The switchback rollers 7A serve as conveying rollers which re-convey the printing sheet. The switchback rollers 7A convey the printing sheet ejected from the fixing device 5P toward the sheet discharge tray 3A until a trailing end, in the conveying direction, of the printing sheet passes through a pair of re-conveying rollers 8A. When the trailing end of the printing sheet pass the pair of re-conveying rollers 8A, the rotation directions of the switchback rollers 7A are reversed.

Then, after a part of the printing sheet protruded towards the sheet discharge tray 3A, the conveying direction of the printing sheet is reversed, and the printing sheet is conveyed toward the image forming device 5 (or, the re-conveying device 20). The rotation directions of the re-conveying rollers 8A are in association with the rotation directions of the switchback rollers 7A.

After the conveying direction is reversed by the switchback rollers 7A, the printing sheet is further conveyed toward the re-conveying device 29 by the re-conveying rollers 8A, the re-conveying device 20 is arranged on a lower side, in the vertical direction, with respect to the sheet feed tray 11 as shown in FIG. 1.

The re-conveying device 20 conveys the printing sheet on an upstream side, in the conveying direction, with respect to a pair of registration rollers 9, that is toward an inlet opening of the image forming device 5. The registration rollers 9 adjust an attitude of the printing sheet, and then convey the printing sheet to the image forming device 5.

As shown in FIG. 2, at a discharge opening 3B, a pair of discharge rollers 3D for discharging the printing sheet, on which au image has been formed, to the sheet discharge tray 3A. The discharge rollers 3D is configured such that the rotation direction is not reversed and is configured to cooperate with the pair of conveying rollers 3E so that the entire printing sheet is discharged onto the sheet discharge tray 3A.

1.2 Sheet Conveying Structure

<Conveying Passage Switching Mechanism>

A passage of the printing sheet from the fixing device 5P to the discharge opening 3B (hereinafter, referred to as a discharging passage L1) and a passage from the switchback discharge opening 3C to the re-conveying device 20 (hereinafter, referred to as a re-conveying passage L2) are communicable through a communication passage L3.

The communication passage L3 is configured to make a portion of discharging passage L1 between the fixing device 5P and the pair of conveying rollers 3E and a portion of the re-conveying passage L2 on the re-conveying device 20 side with respect to the pair of re-conveying rollers 8A communicate with each other.

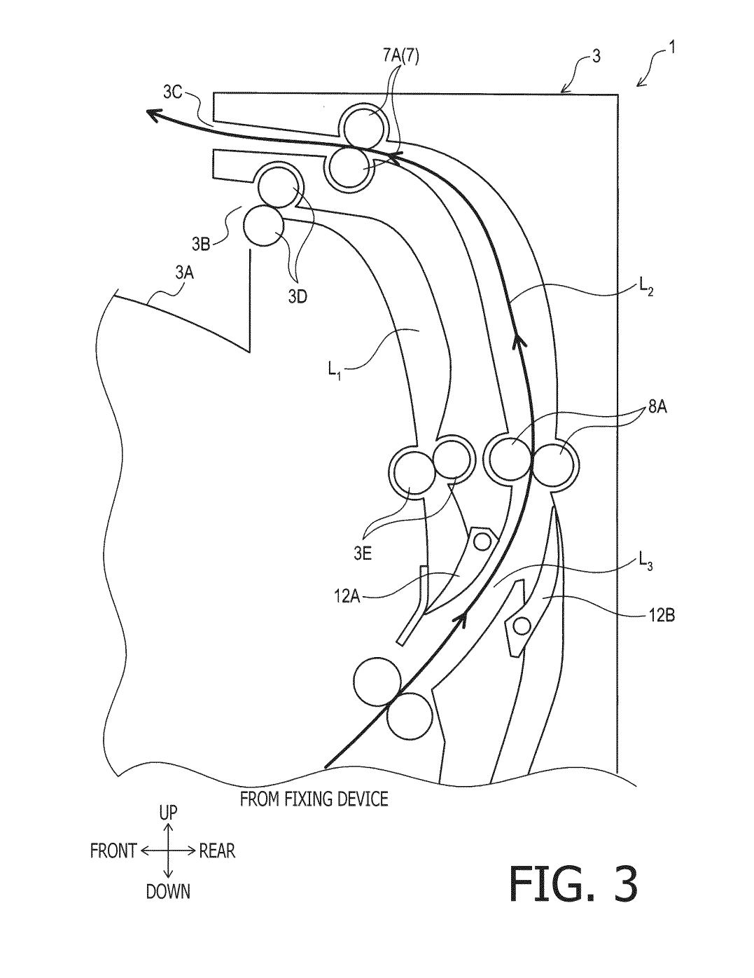

On the discharging passage L1 side of the communication passage L3, a first passage switching member 12A is provided. On the re-conveying passage L2 side of the communication passage L3, a second passage switching member 1213 is provided. The first passage switching member 12A is configured to switch between a case where the printing sheet discharged from the fixing device 5P is directed to the discharge opening 313 (as shown in FIG. 2) and a case where the printing sheet discharged from the fixing device 5P is directed to the communication passage L3 (as shown in FIG. 3).

The second switching member 12B is configured to switch between a case where the communication passage L3 is closed so that the printing sheet is prevented from entering the communication passage L3 (as shown in FIG. 2) and a case where the communication. passage L3 is opened so that the printing sheet directed to the communication passage L3 is directed to the switchback discharge opening 3C (as shown in FIG. 3).

In the following description, positions of the first passage switching member 12A and the second passage switching member 1213 shown in FIG. 2 will be referred to as closed positions, while, positions thereof shown in FIG. 3 will be referred to as open positions.

<Conveyance of Printing Sheet in Simplex Mode>

In the simplex printing mode, at least the first passage switching member 12A is positioned to the closed position as shown in FIG. 2. Then, the printing sheet discharged from the fixing device 5P is directed to the discharge opening 3B and discharged onto the sheet discharge tray 3A, without entering the communication passage L3.

<Conveyance of printing Sheet in Duplex Mode>

When transfer of the developing agent on one surface (i.e., front surface) of the printing sheet has completed, the first passage switching member 12A and the second passage switching member 12B are positioned to the open positions as shown in FIG. 3. Then, the printing sheet discharged from the fixing device 5P enters the communication passage L3 and is directed toward the switchback discharge opening 3C.

When the trailing end, in the conveying direction, of the printing sheet directed toward the switchback discharge opening 3C has passed the pair of re-conveying rollers 8A, the first passage switching member 12A and the second passage switching member 12B are positioned to the closed positions as shown in FIG. 2.

After or at the same time when the first passage switching member 12A and the second passage switching member 12B has been positioned to the closed positions, rotation directions of the pair of switchback rollers 7A and the pair of re-conveying rollers 8A are reversed.

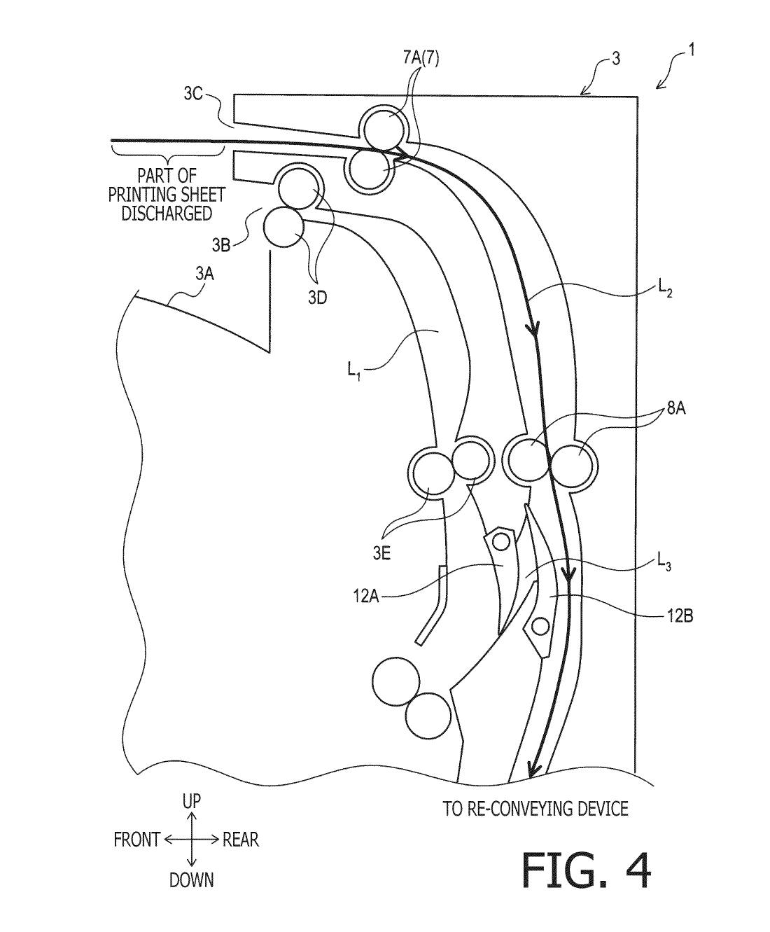

Then, as shown in FIG. 4, the printing sheet does not enter the communication passage L3 as the conveying direction is reversed, and is conveyed toward the re-conveying device 20. It is noted that, until the rotation directions of the pair of switchback rollers 7A and the pair of the re-conveying rollers 8A are reversed, a part of the printing sheet is discharged from the opening toward the sheet discharge tray 3A.

When the developing agent has been transferred to the back surface of the printing sheet (i.e., when the developing agent has been transferred to both surfaces of the printing sheet), at least the first passage switching member 12A is positioned to the closed position as shown in FIG. 2. Then, the printing sheet discharged from the fixing device 5P is directed toward the discharge opting 3B, without entering the communication passage L3, and discharged onto the sheet discharge tray 3A.

2. First Projection-Forming Part and Second Projection-Forming Pant

The image forming Apparatus 1 is configured to form deflection which projects in a thickness direction of the printing sheet (hereinafter, such a deflection will be referred to as corrugation) on at least one of the printing sheet discharged from the discharge opening 3B (hereinafter, referred to as discharged sheet) and the printing sheet discharged from the switchback discharge opening 3C (hereinafter, referred to as switchback sheet).

According to the illustrative embodiment, the corrugations are formed on both the discharge sheet and the switchback sheet. It is noted that at least one corrugation projecting in the thickness direction is sufficient for each printing sheet, and the corrugation may project toward the front surface side or the back surface side.

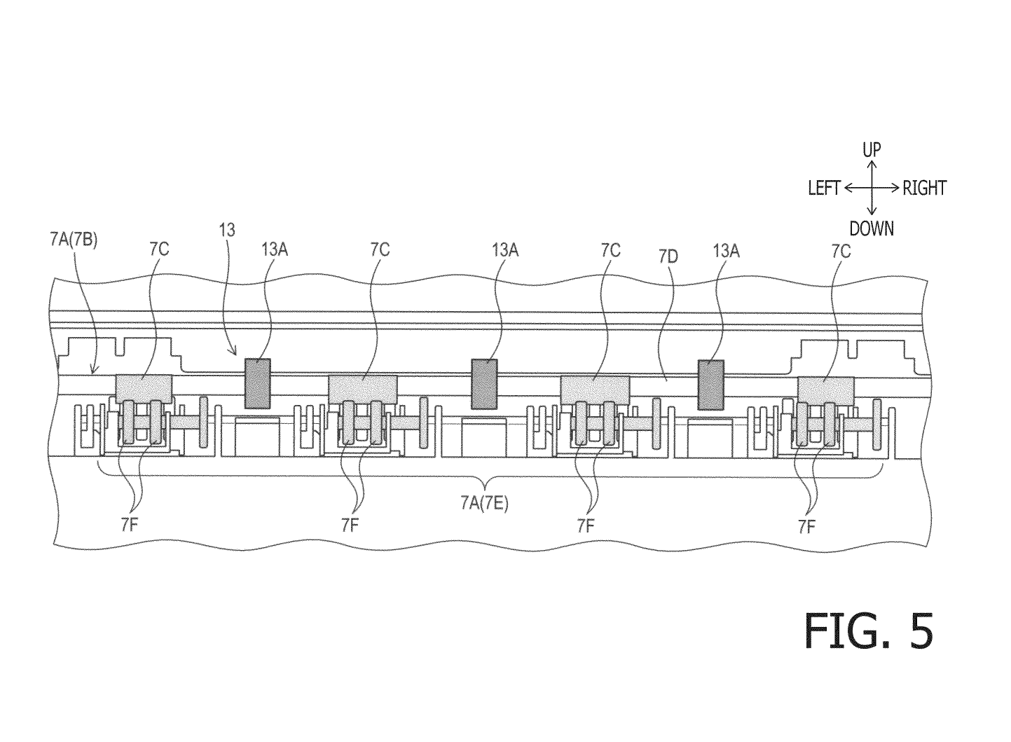

As shown in FIG. 5, the first projection-forming part 13 forms multiple corrugations on the switchback sheet. The first projection-forming part 12 has a pair switchback rollers 7A and at least one projection-forming disk member 13A.

<First Projection-Forming Part>

In the following description, one of the switchback rollers 7A will be referred to as a first switchback roller 7B and the other of the switchback rollers 7A will be referred to as a second switchback roller 7E. The first switchback roller 7B has multiple first roller parts 7C and a single first roller shaft. 7D.

The multiple first roller parts 7C contact the switchback sheet and apply a conveying force to the switchback sheet. The first roller shaft 7D supports the first roller parts 7C and transmits a rotational force to the first roller parts 7C.

The second switchback roller 7E has multiple first pinch rollers 7F. The multiple first pinch rollers 7F are arranged to face the multiple first roller parts 7C, respectively, and urge the switchback sheet onto the first roller parts 7C.

The projection-forming disk members 13A are arranged at positions shifted with respect to the first roller parts 7C, respectively. The projection-forming disk members 13A are arranged along the same axis along which the first switchback roller 7B are arranged. A diameter of the projection-forming disk member 13A is larger than a diameter of the first roller 7C.

According to the illustrative embodiment, there are multiple projection-forming disk members 13A. The multiple projection-forming disk members 13A contact the switchback sheet from the above, in the vertical direction. It is noted that the multiple projection-forming disk members 13A are secured to the first roller shaft 7D. Each of the projection-forming disk member 13A secured to the first roller shaft 7D and rotated in association with the first switchback rollers 7B.

Because of the above-described configuration, portions of the switchback sheet nipped between the first switchback roller 7B and the second switchback rollers 7E and portions of the switchback sheet where the projection-forming disk members 13A contact are different levels (i.e., heights) in the thickness direction of the switchback sheet. As a result, on the switchback sheet, a corrugation having multiple projection-forming parts.

<Second Projection-Forming Part>

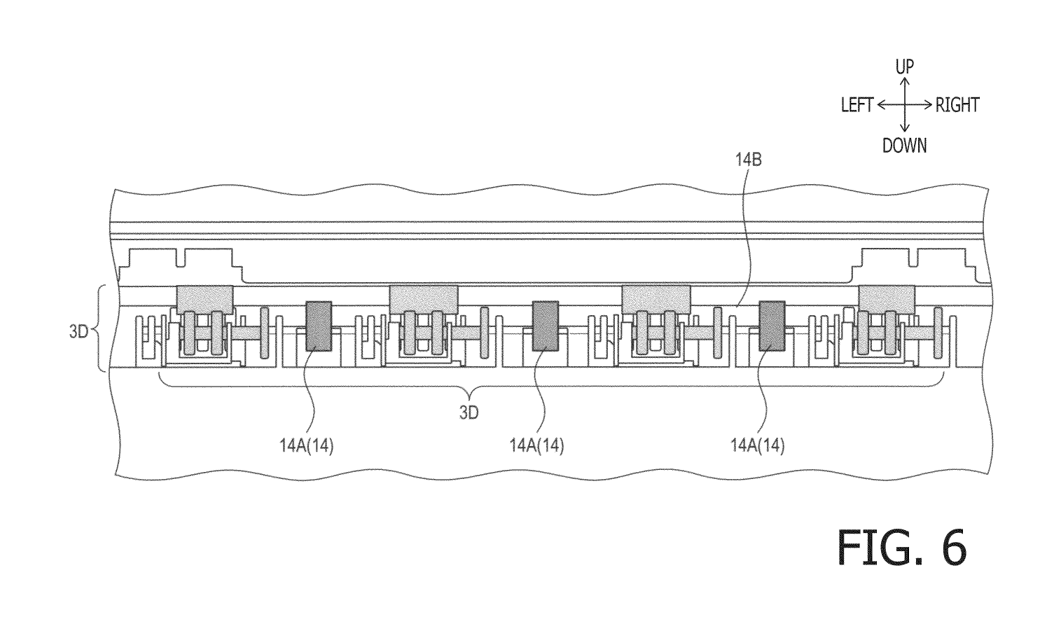

The second projection-forming part 14 shown in FIG. 6 is configured to form a corrugation on the discharge sheet. The second protrusion-forming part 14 has a pair of discharge rollers 3D and at least one conveying rib 14A. It is noted that the structure of the pair of discharge rollers 3D is the same as the pair of switchback rollers 7A, and description thereof will be omitted for brevity.

The conveying rib 14A is a projected part, and formed on a fixed member 14B such as a guide member guiding the discharge sheet, or a frame supporting the pair of discharge rollers 3D. According to the illustrative embodiment, multiple conveying ribs 14A are provided. According o the illustrative embodiment, the multiple conveying ribs 14A slidably contact the discharge sheet from below in the vertical direction.

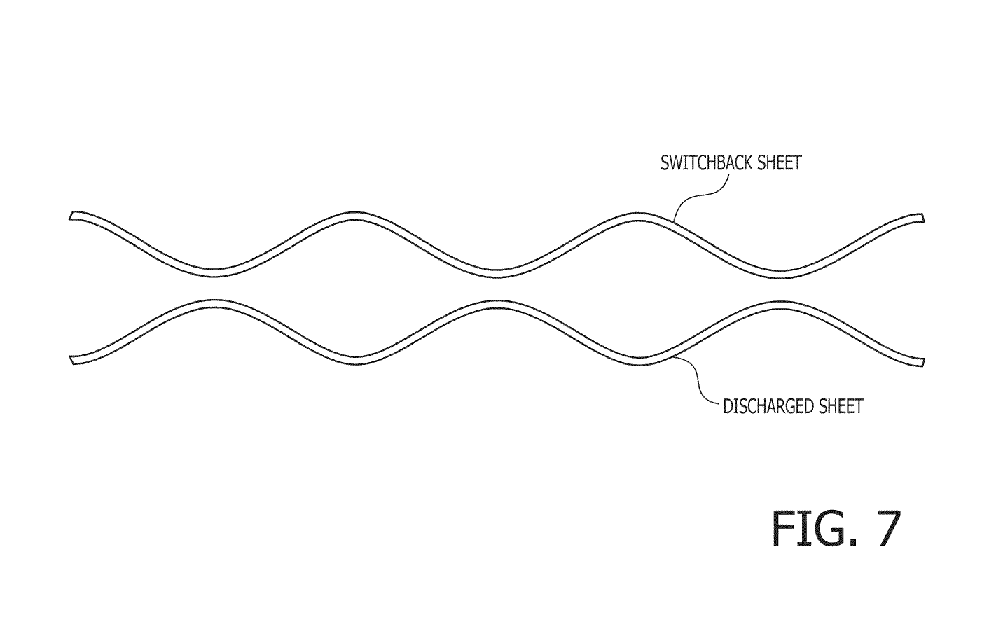

A portion of the discharged sheet nipped by the pair of discharge rollers 3D and portions where the multiple conveying ribs 14A contact are displaced in the thickness direction of the discharge sheet. Accordingly, as shown in FIG. 7, the corrugation having multiple projections is formed on the discharge sheet.

<Corrugations Formed on Sheets>

The first projection-forming part 13 and the second projection-forming part 14 are configured such that the corrugation formed on the switchback sheet and the corrugation formed on the discharge sheet are not congruent as shown in FIG. 7.

According to the illustrative embodiment, each of the corrugations formed on the switchback sheet and the discharge sheet has a deflective shape forming a wavelike or an undulating cross section, Further, the corrugation formed on the switchback sheet and the corrugation formed on the discharge sheet have shapes shifted such that phases thereof have a please deviation of half a period.

3. Features of Image Forming Apparatus

According to the illustrative embodiment, the corrugation is formed on at least one of the discharge sheet discharged from the discharge opening 3B and the switchback discharged from the switchback discharge opening 3C such that the corrugation includes one or more projected parts in the thickness direction.

Because of the above configuration, even if the switchback sheet and the discharge sheet contact each other, a contacting area can be made relatively small. Accordingly, an attracting force generated between the switchback sheet and the discharge sheet can also be made relatively small.

Therefore, a situation that the discharge sheet is attracted by the switchback sheet, which is being re-conveyed, and drawn toward the discharge opening 3B can be suppressed. That is, the jam phenomenon due to the attraction of the discharge sheet by the switchback sheet can be suppressed.

It is noted that the switchback discharge opening 3C is formed on an upper side, in the vertical direction, with respect to the discharge opening 3B, and the first projection-forming part 13 is configured to form the deflections (i.e., projected parts) to the switchback sheet discharged from the switchback discharge opening 3C.

As above, since the deflection rigidity of the switchback sheet can be made higher. Therefore, the switchback sheet can be prevented from deflecting downward toward the discharge sheet. Since contact of the switchback sheet with respect to the discharge sheet can be suppressed as described above, occurrence of the jam phenomenon can be well suppressed.

According to the illustrative embodiment, the corrugation formed by the first projection-forming part 13 and the corrugation formed by the second projection-forming part 14 are not congruent with respect to each other. Therefore, a contacting area between the switchback sheet and the discharge sheet can be surely reduced. Accordingly, occurrence of the jam phenomenon can be well suppressed.

### Other Embodiments

In the above-described illustrative embodiment, a mechanism constituting the first projection-forming part 12 (hereinafter, referred to as a first mechanism) and a mechanism constituting the second projection-forming part 14 (hereinafter, referred to as a second mechanism) are different configurations. Aspects of the disclosure need not be limited to such configurations.

For example, four different modified embodiments can be configured beside the above-described illustrative embodiment in terms of the first and second mechanisms. Such modified embodiments include:

(a) both the first projection-forming part 13 and the second projection-forming part 14 being configured by the first mechanism;

(b) both the first projection-forming part 13 and the second projection-forming part 14 being configured by the second mechanism;

(c) the first projection-forming part 13 being configured by the second mechanism and the second projection-forming part 14 being configured by the first mechanism; and

(d) both the first projection-forming part 13 and the second projection-forming part 14 being configured by a mechanism other than the first mechanism or the second mechanism.

In the above-described illustrative embodiment, the projection-forming disk members 13A contact the switchback sheet from the upper side in the vertical direction, and the multiple conveying ribs 14A contact the discharge sheet from the lower side in the vertical direction. The aspects of the disclosures should not be limited to such configurations.

According to aspects of the disclosures, it may be sufficient if the corrugation formed on the switchback sheet and the corrugation formed on the discharge sheet are not congruent. Therefore, for example, the projection-forming disk members 13A may contact the switchback sheet from the lower side in the vertical direction, and the multiple conveying ribs 14A may contact the discharge sheet from the upper side in the vertical direction.

Although not explicitly described, any configuration according to the aspects of the disclosures could be considered within a scope of the claims.

What is claimed is:

1. An image forming apparatus, comprising:
an image forming device configured to form images on a printing sheet;
a sheet discharge tray configured to receive the printing sheet on which image formation by the image forming device has been completed;
a switchback mechanism configured to reverse a conveying direction of the printing sheet to re-convey the printing sheet toward the image forming device;
a casing accommodating the image forming device, the casing having:
a discharge opening through which the printing sheet is discharged from inside of the casing to outside of the casing; and
a switchback discharge opening through which a part of the printing sheet is projected toward the sheet discharge tray; and
a first projection-forming device configured to form a corrugation on at least one of a first, printing sheet a part of which is projected toward the sheet discharge tray through the switchback discharge opening and a second printing sheet which is to be discharged onto the sheet discharge tray through the discharge opening, the corrugation having at least one deflection which projects in a direction of thickness of the printing sheet.

2. The image forming apparatus according to claim 1,
wherein the switchback discharge opening is arranged on an upper side in a vertical direction with respect to the discharge opening, and
wherein the first projection-forming device is configured to form the corrugation on the first printing sheet.

3. The image forming apparatus according to claim 2,
further comprising a second projection-forming device configured to form a corrugation on the printing sheet discharged toward the sheet discharge tray through the discharge opening, the corrugation having at least one deflection in a direction of thickness of the first printing sheet,
wherein the corrugation formed on the first printing sheet by the first projection-forming device and the corrugation formed on the second printing sheet by the second projection-forming device are not congruent.

4. The image forming apparatus according to claim 3, wherein the corrugation formed by the first projection-forming device and the corrugation formed by the second projection-forming device are wavelike corrugations having a phase deviation of half a period.

5. The image forming apparatus according to claim 1,
wherein the switchback discharge opening is arranged on an upper side in a vertical direction with respect to the discharge opening, and
wherein the first projection-forming device is configured to form the corrugation on the second printing sheet.

6. The image forming apparatus according to claim 1, wherein the switchback mechanism comprises switchback rollers configured to rotate in both forward and reverse directions to convey the printing sheet, the conveying direction of the printing sheet being switched as the rotation directions of the switchback rollers are switched.

7. The image forming apparatus according to claim 1, wherein the first projection-forming device has one or more conveying ribs configured to slidably contact at least one of the first printing sheet and the second printing sheet.

8. The image forming apparatus according to claim 1, wherein the first projection-forming device comprises:
a conveying roller configured to convey one of the first printing sheet and the second printing sheet; and
one or more disk members arranged coaxially with the conveying roller, the one or more disk members having a larger diameter than a diameter of the conveying roller, the one or more disk members forming one or more protrusions on the one of the first printing sheet and the second printing sheet.
